(19) United States
(12) Patent Application Publication
(10) Pub. No.: US 2026/0370795 A1
(43) Pub. Date: Nov. 19, 2026

(54) INFORMATION PROCESSING DEVICE, INFORMATION PROCESSING METHOD, AND COMPUTER-READABLE NON-TRANSITORY STORAGE MEDIUM

(71) Applicant: Sony Group Corporation, Tokyo (JP)

(72) Inventors: Ryohei FUNAKOSHI, Tokyo (JP); Tsutomu ICHINOSE, Tochigi (JP)

(73) Assignee: Sony Group Corporation, Tokyo (JP)

(21) Appl. No.: 19/154,229

(22) PCT Filed: Jan. 5, 2024
(86) PCT No.: PCT/JP2024/000042

§ 371 Date: Aug. 6, 2025

(30) Foreign Application Priority Data
Feb. 17, 2023 (JP) 2023-023432

(51) Int. Cl. H04N 13/383; H04N 13/282

(52) U.S. Cl. CPC H04N 13/383; H04N 13/282

(57) ABSTRACT

An information processing device includes a rendering unit, a time prediction unit, a user position prediction unit, and a viewpoint/line-of-sight setting unit. The rendering unit generates an image having motion parallax according to the viewpoint and the line of sight of the user. The time prediction unit predicts the display delay of the image of the target frame to be rendered on the basis of the display delay measured for the frame before the target frame. The user position prediction unit predicts the viewpoint and the line of sight of the user at the time when the image of the target frame is predicted to be displayed on the basis of the prediction result of the display delay r. The viewpoint/line-of-sight setting unit sets the viewpoint and the line of sight of the user as the viewpoint and the line of sight of rendering when an image of a target frame is generated.

### FIELD

The present invention relates to an information processing device, an information processing method, and a computer-readable non-transitory storage medium.

### BACKGROUND

There is known a rendering system that generates an image according to a viewpoint and a line of sight of a user using head tracking or the like. In this type of rendering system, rendering is performed such that motion parallax corresponding to the motion of the head of the user is given. Therefore, natural stereoscopic vision is possible.

### CITATION LIST

### Patent Literature

Patent Literature 1: JP 2022-158328 A

### SUMMARY

### Technical Problem

In the above-described rendering system, a display delay called motion to photon becomes a problem. The display delay is calculated as the total time (delay time) until the fluctuations of the viewpoint and the line of sight are reflected in the video of the screen. When there is a display delay, a video slightly shifted from a video to be originally displayed is displayed.

In Patent Literature 1, this shift of the video is suppressed by reprojection processing. The reprojection processing means processing (warping) of the generated video to match the posture of the user at the time of displaying the video. However, accurate reproduction such as a difference in occlusion portion and specular reflection is not performed only by warping the video after rendering.

Therefore, the present disclosure proposes an information processing device, an information processing method, and a non-transitory storage medium capable of suppressing a deviation of a video due to a display delay.

### Solution to Problem

According to the present disclosure, an information processing device is provided that comprises: a rendering unit that generates an image having motion parallax according to a viewpoint and a line of sight of a user; a time prediction unit that predicts a display delay of an image of a target frame to be rendered on a basis of a display delay measured for a frame before the target frame; a user position prediction unit that predicts a viewpoint and a line of sight of the user at a time when an image of the target frame is predicted to be displayed on a basis of a prediction result of the display delay; and a viewpoint/line-of-sight setting unit that sets the predicted viewpoint and line of sight of the user as a viewpoint and line of sight of rendering when an image of the target frame is generated. According to the present disclosure, an information processing method in which an information process of the information processing device is executed by a computer, and a computer-readable non-transitory storage medium storing a program for causing the computer to execute the information process of the information processing device, are provided.

### BRIEF DESCRIPTION OF DRAWINGS

FIG. 1 is a diagram illustrating a schematic configuration of a rendering system.

FIG. 2 is a diagram illustrating a system configuration example of the rendering system.

FIG. 3 is a diagram for explaining an outline of information processing performed by a tracking application and a rendering application.

FIG. 4 is a diagram illustrating an example of rendering processing in a case where prediction of a viewpoint and a line of sight is not performed.

FIG. 5 is a diagram illustrating an example of rendering processing in a case where prediction of a viewpoint and a line of sight is not performed.

FIG. 6 is a diagram illustrating an example of rendering processing in a case where a viewpoint and a line of sight are predicted.

FIG. 7 is a diagram illustrating an example of rendering processing in a case where a viewpoint and a line of sight are predicted.

FIG. 8 is a diagram illustrating an example of a hardware configuration of an information processing device.

### DESCRIPTION OF EMBODIMENTS

Hereinafter, embodiments of the present disclosure will be described in detail with reference to the drawings. In the following embodiments, the same parts are denoted by the same reference numerals, and redundant description will be omitted.

Note that the description will be given in the following order.
[1. Rendering system]
[2. System configuration example]
[3. Information processing method]
[4. Hardware configuration example]
[5. Effects]

### 1. Rendering System

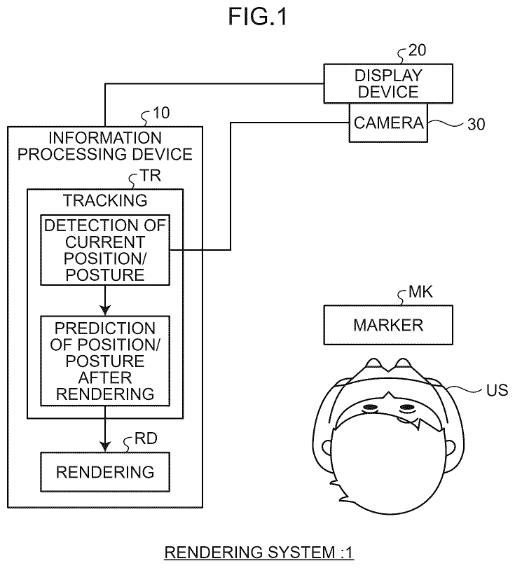

FIG. 1 is a diagram illustrating a schematic configuration of a rendering system 1.

The rendering system 1 is a system that generates an image having motion parallax according to the viewpoint and the line of sight of a user US using a head tracking technique or the like. A method of detecting the viewpoint and the line of sight is arbitrary. The viewpoint and the line of sight of the user US may be detected using measurement information of a sensor (such as a gyro sensor or an angular speed sensor) attached to the head of the user US, or the viewpoint and the line of sight of the user US may be detected using a captured image of a marker MK attached to the head of the user US. In the example of FIG. 1, the viewpoint and the line of sight are detected using the marker MK.

For example, the rendering system 1 includes an information processing device 10, a display device 20, and a camera 30. The camera 30 captures an image of the marker MK attached to the head of the user US. The information processing device 10 detects the position and posture of the head of the user US on the basis of the position and posture of the marker MK captured in the camera 30. The information processing device 10 detects the viewpoint and the line of sight of the user US on the basis of the position and posture of the head. The information processing device 10 generates an image having motion parallax according to the viewpoint and the line of sight of the user US, and outputs the image to the display device 20.

The generated image is transferred to the display device 20 via a buffer of the GPU. When the viewpoint or the line of sight of the user US moves between the start of rendering and the final display, a deviation occurs between the viewpoint and the line of sight used for the rendering and the viewpoint and the line of sight when actually viewing the image. As a result, there are problems such as visually induced motion sickness due to distortion of a perceived space and occurrence of crosstalk in the case of naked eye stereoscopic vision.

Therefore, the information processing device 10 monitors the movement of the viewpoint and the line of sight of the user US and the delay (display delay) in the image display processing, and predicts the viewpoint and the line of sight of the user US when the image is actually viewed. The display delay means a time until the command operation (for example, rendering command) is reflected on the display screen.

The information processing device 10 sets the predicted viewpoint and line of sight of the user US as the viewpoint and line of sight of rendering of a frame to be rendered (target frame). As a result, an image matching the viewpoint and the line of sight of the user US at the moment when the display is actually performed is generated, and the occurrence of perspective distortion and crosstalk is reduced.

Note that it is also conceivable to register a display delay in advance as system information and collectively correct the viewpoint and the line of sight for all frames. However, the time required for rendering varies depending on the data amount of the content to be displayed, the PC specification, the type of software used to display the content, and the like. Since the necessary correction amount varies depending on the content or the like, it is difficult to perform correction assuming that the rendering time is a fixed value. Hereinafter, a specific description will be given.

### 2. System Configuration Example

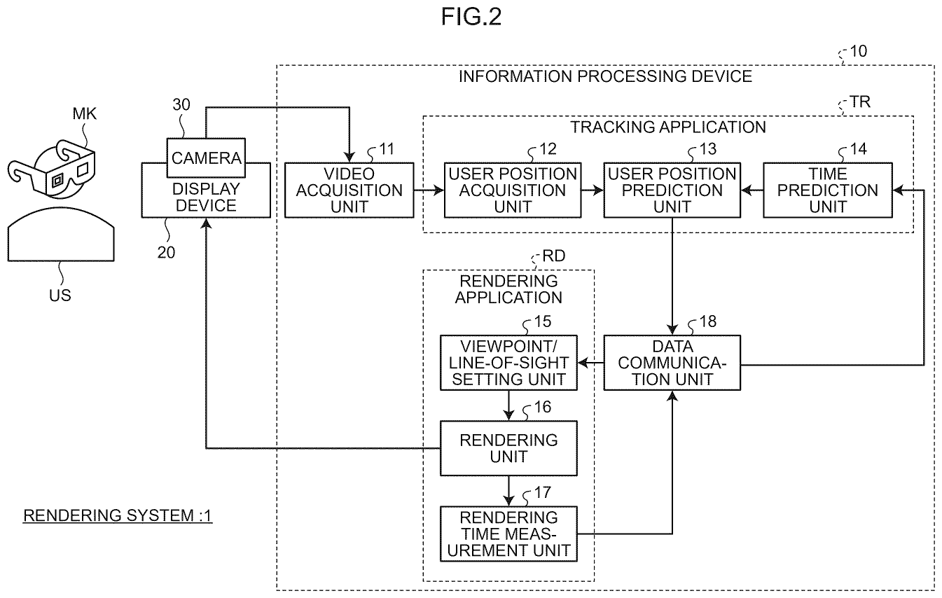

FIG. 2 is a diagram illustrating a system configuration example of the rendering system 1.

The information processing device 10 includes a video acquisition unit 11, a user position acquisition unit 12, a user position prediction unit 13, a time prediction unit 14, a viewpoint/line-of-sight setting unit 15, a rendering unit 16, a rendering time measurement unit 17, and a data communication unit 18.

The user position acquisition unit 12, the user position prediction unit 13, and the time prediction unit 14 indicate a functional configuration of a tracking application TR. The viewpoint/line-of-sight setting unit 15, the rendering unit 16, and the rendering time measurement unit 17 indicate a functional configuration of a rendering application RD. The tracking application TR tracks the user US on the basis of the video of the camera 30. The rendering application RD performs rendering processing according to the tracking result. In the present disclosure, the plurality of functional configurations described above are distributed as illustrated in FIG. 2, but a system developer can arbitrarily set which functional configuration is shared by which application.

The video acquisition unit 11 acquires a video of the user US captured by the camera 30. In the video, a marker MK for head tracking attached to the head of the user US is shown. For example, the marker MK includes a plurality of infrared LEDs (Light-Emitting Diodes) whose positional relationships are known. The marker MK changes the position and posture according to the movement of the head of the user US.

The user position acquisition unit 12 acquires the position and posture of the head of the user US by analyzing the video of the marker MK (arrangement of bright spot groups obtained by the emission of the infrared LED). As the analysis method, a known method such as PnP (Perspective-n-Point) is used. The user position acquisition unit 12 acquires the viewpoint and the line of sight of the user US on the basis of the position and posture of the head of the user US.

Tracking without using the marker MK is also possible. For example, the user position acquisition unit 12 may detect the face of the user US and perform PnP calculation with an average face shape to estimate the viewpoint and the line of sight of the user US. In addition, by combining such a method with three-dimensional measurement of a face using a depth camera, it is also possible to improve the estimation accuracy of the line of sight and the viewpoint.

The time prediction unit 14 predicts a display delay for an image to be generated on the basis of the rendering history information acquired from the rendering application RD. For example, the time prediction unit 14 acquires the display delay as the time from the start of rendering until the image generated by the rendering is displayed on the display screen of the display device 20.

For example, a frame to be rendered is set as a target frame, and a frame rendered before the target frame is set as a past frame. The past frame is, for example, a frame one frame before the target frame. The time prediction unit 14 predicts the display delay of the image of the target frame to be rendered on the basis of the display delay measured for the past frame before the target frame.

The user position prediction unit 13 predicts the viewpoint and the line of sight of the user US at the time when the image of the target frame is predicted to be displayed on the basis of the information (viewpoint/line-of-sight information) of the viewpoint and the line of sight of the user US at the time when the image of the past frame is displayed and the prediction result of the display delay for the target frame.

The viewpoint/line-of-sight information can include information regarding a moving speed of the viewpoint and the line of sight of the user. For example, the user position prediction unit 13 predicts the viewpoint and the line of sight of the user US at the time when the image of the target frame is predicted to be displayed on the basis of the prediction result of the display delay, the viewpoint and the line of sight of the user US at the start time of rendering of the target frame, and the moving speed of the viewpoint and the line of sight of the user US at the start time of rendering of the target frame.

The user position prediction unit 13 can predict the viewpoint and the line of sight of the user US on the basis of simple prediction assuming that the moving direction and the moving speed of the viewpoint and the line of sight of the user US are unchanged before and after the rendering start time.

The viewpoint/line-of-sight setting unit 15 acquires the prediction result of the viewpoint and the line of sight from the user position prediction unit 13 via the data communication unit 18. The viewpoint/line-of-sight setting unit 15 sets the viewpoint and the line of sight of the user US predicted by the user position prediction unit 13 as the viewpoint and the line of sight of rendering when an image of a target frame is generated.

The rendering unit 16 performs rendering on the basis of the viewpoint and the line of sight set by the viewpoint/line-of-sight setting unit 15, and generates an image having motion parallax corresponding to the viewpoint and the line of sight of the user US. The display device 20 displays the image of the target frame generated by the rendering. There is no large deviation between the viewpoint and the line of sight of the rendering and the viewpoint and the line of sight of the user US when the image is actually viewed. Since an image is generated in accordance with the viewpoint and the line of sight of the user US at the moment when display is actually performed, perspective distortion and crosstalk hardly occur. Note that the rendering processing may include known reprojection processing.

The rendering time measurement unit 17 measures the rendering time for each frame. The rendering time means the time taken from the start to the end of rendering. The rendering time measurement unit 17 stores the rendering time of one or more frames including the latest frame as rendering history information. The number of frames to be stored can be arbitrarily set by the system developer on the basis of the number of frames to be used for the prediction calculation of the display delay.

A method of measuring the rendering time is arbitrary. Known rendering applications such as Unity and UE4 have a function of measuring a rendering time. The rendering application RD of the present disclosure can also have a similar measurement function.

The time prediction unit 14 acquires the rendering time of the past frame to be used for the prediction calculation from the rendering time measurement unit 17 via the data communication unit 18. The time prediction unit 14 predicts the display delay of the image of the target frame by using the rendering time of the past frame.

### 3. Information Processing Method

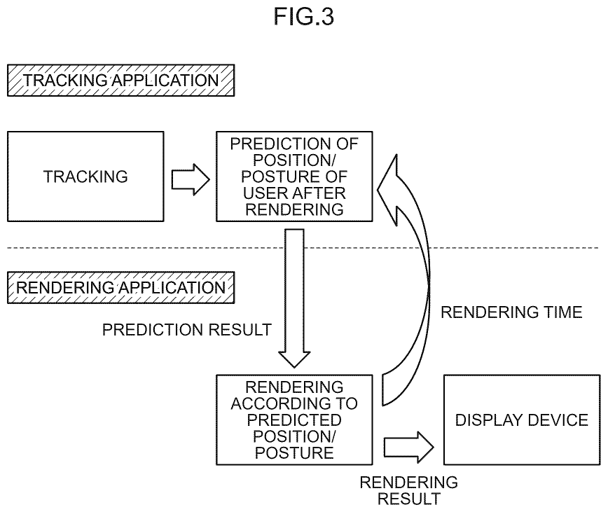

FIG. 3 is a diagram for explaining an outline of information processing performed by the tracking application TR and the rendering application RD.

The tracking application TR tracks the position and posture of the head of the user US using a head tracking technology. The tracking application TR predicts a display time of a target frame to be rendered and a viewpoint and a line of sight of the user US according to the position and the posture of the user US at the display time on the basis of the information of the position and the posture of the user US and the information of the rendering time of the past frame grasped from the tracking result.

The rendering application RD renders the target frame on the basis of the prediction result of the viewpoint and the line of sight acquired from the tracking application TR. The rendering application RD transmits the rendering result of the target frame to the display device 20, and transmits the rendering time of the target frame to the tracking application TR. The rendering time of the target frame is used to predict a viewpoint and a line of sight when the next frame of the target frame is rendered.

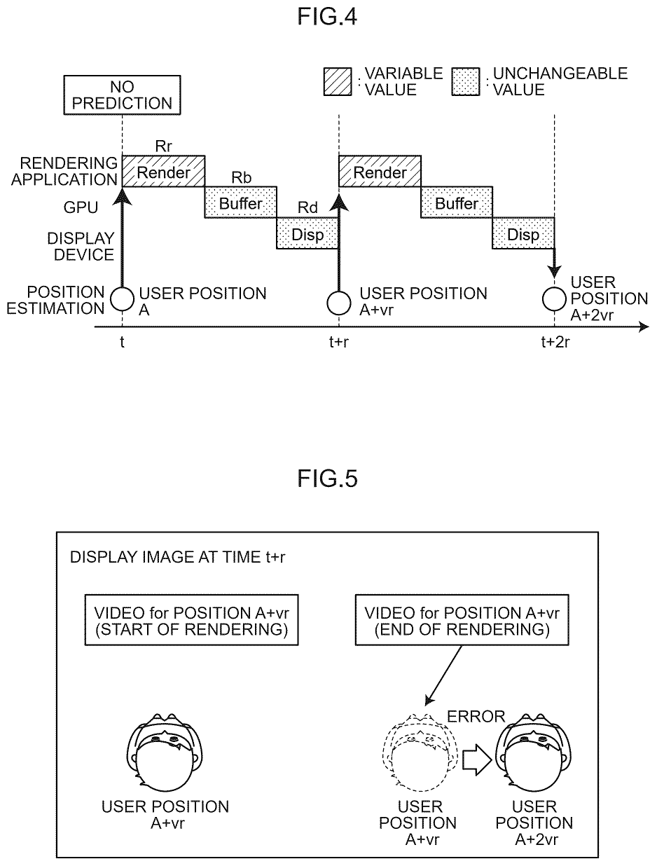

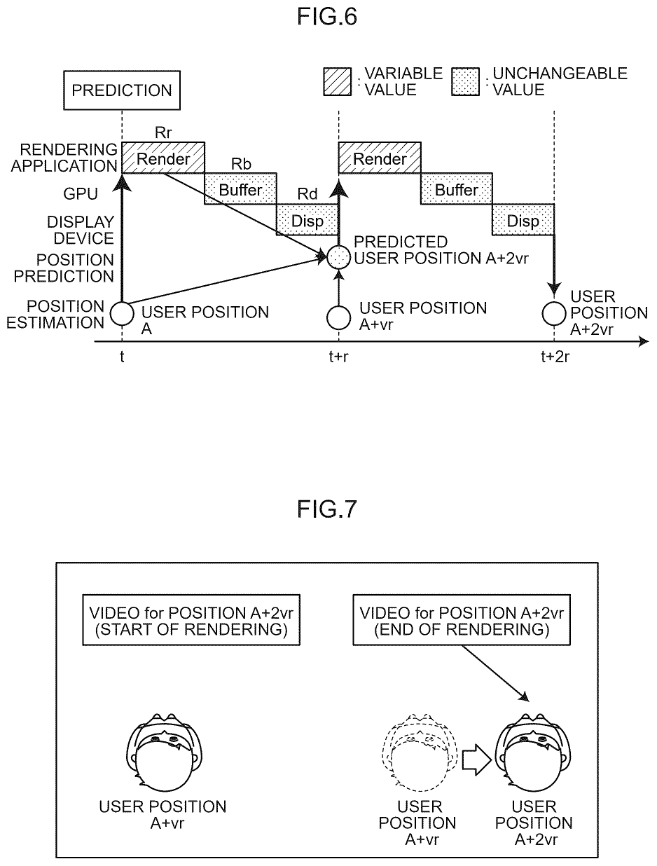

FIGS. 4 and 5 are diagrams illustrating a rendering processing example (comparative example) in a case where the viewpoint and the line of sight are not predicted. FIGS. 6 and 7 are diagrams illustrating a rendering processing example (embodiment) in a case where the viewpoint and the line of sight are predicted.

In order to simplify the description, a case where the user US performs a uniform linear motion in front of the display device 20 will be considered. The initial position of the user US is “A”, the moving speed of the user US is “v”, and the time (display delay) from the start of rendering until the rendering result is presented to the user US is “r”. The display delay r is expressed as r=R_{b}+R_{b}+Rₐ using a rendering time Rᵣ, a buffer time R_{b}, and a response time R_{d}.

The rendering time Rᵣ is a time required from the start to the end of rendering. The buffer time Rₚ is a time for holding a rendering result in a buffer of a graphics processing unit (GPU). The response time Rₐ is a time at which the data held in the buffer is displayed on the display screen. The buffer time R_{b} and the response time Rₐ are fixed values according to the hardware configuration. The rendering time Rᵣ is a variable value that varies depending on the complexity of the content to be rendered. The time prediction unit 14 calculates a time obtained by adding the buffer time R_{b} and the response time R_{d} to the rendering time Rᵣ as the display delay r.

In the comparative example (FIGS. 4 and 5), since the viewing position is not predicted, the image rendered for the current position is viewed at a position advanced from the current position by the display delay r. In the example of FIG. 5, rendering is started at time (t+r).

The rendered image is displayed on the display screen at time (t+2r) that is ahead of the rendering start time (t +r) by the display delay r. The user US views the image at the position (A+2vr) ahead of the position (A+vr) at the rendering start time (t+r) by vr. This deviation appears as distortion, crosstalk, or the like of the perceived stereoscopic image.

In the embodiment (FIGS. 6 and 7), the display delay r is calculated on the basis of the tracking result of the user US, the rendering time Rᵣ received from the rendering application RD, and the delay time (buffer time R_{b}, response time R_{d}) for each system measured in advance. A time ahead of the rendering start time by the display delay r is calculated as the display time of the target frame to be rendered.

In the example of FIG. 7, rendering is started at time (t+r). The tracking application TR calculates the time (t+2r) as the display time of the target frame. The tracking application TR predicts the position (A+2vr) of the user US at the display time (t+2r) of the target frame, and transmits the position to the rendering application RD. As a prediction method, simple prediction of predicting a position moved by the same amount as the previous movement amount as the position of the movement destination, prediction by linear function fitting, or the like can be used. In the present disclosure, for example, simple prediction is used as a prediction method.

The user US moves forward by vr from the rendering start time (t+r) to the display time (t+2r). The user US will view the image rendered towards the location (A+2vr) from the location (A+2vr). Therefore, it is possible to feel the video with less deviation without being affected by the delay.

### 4. Hardware Configuration Example

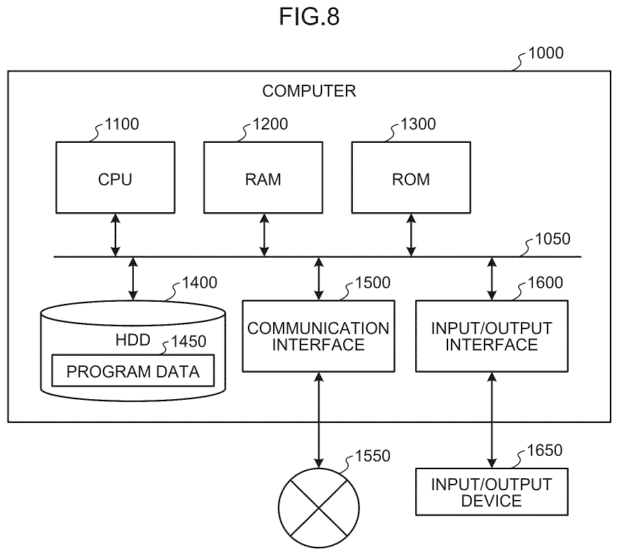

FIG. 8 is a diagram illustrating an example of a hardware configuration of the information processing device 10.

The information processing of the information processing device 10 is realized by, for example, a computer 1000. The computer 1000 includes a central processing unit (CPU) 1100, a random access memory (RAM) 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program (program data 1450) stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a non-transitory computer-readable recording medium that non-transiently records a program executed by the CPU 1100, data used by the program, and the like. Specifically, the HDD 1400 is a recording medium that records the information processing program according to the embodiment as an example of the program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display device, a speaker, or a printer via the input/output interface 1600. Furthermore, the input/output interface 1600 may function as a media interface that reads a program or the like recorded in a predetermined recording medium (media). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing device 10 according to the embodiment, the CPU 1100 of the computer 1000 implements the functions of the above-described units by executing the information processing program loaded on the RAM 1200. In addition, the HDD 1400 stores an information processing program, various models, and various data according to the present disclosure. Note that the CPU 1100 reads the program data 1450 from the HDD 1400 and executes the program data, but as another example, these programs may be acquired from another device via the external network 1550.

### 5. Effects

The information processing device 10 includes a rendering unit 16, a time prediction unit 14, a user position prediction unit 13, and a viewpoint/line-of-sight setting unit 15. The rendering unit 16 generates an image having motion parallax according to the viewpoint and the line of sight of the user US. The time prediction unit 14 predicts the display delay r of the image of the target frame to be rendered on the basis of the display delay r measured for a frame before the target frame. The user position prediction unit 13 predicts the viewpoint and the line of sight of the user US at the time when the image of the target frame is predicted to be displayed on the basis of the prediction result of the display delay r. The viewpoint/line-of-sight setting unit 15 sets the viewpoint and the line of sight of the user US as the viewpoint and the line of sight of rendering when an image of a target frame is generated. In the information processing method of the present disclosure, the processing of the information processing device 10 is executed by the computer. The computer-readable non-transitory storage medium of the present disclosure stores a program for causing the computer 1000 to implement processing of the information processing device 10.

According to this configuration, a large deviation does not occur between the viewpoint and the line of sight of the rendering and the viewpoint and the line of sight of the user US when the image is actually viewed. Since the image is generated in accordance with the viewpoint and the line of sight of the user US at the moment when the display is actually performed, the video deviation (perspective distortion, crosstalk, or the like) due to the display delay r is unlikely to occur.

The time prediction unit 14 predicts the display delay r of the target frame on the basis of the display delay r measured for a frame one frame before the target frame.

According to this configuration, the prediction accuracy of the viewpoint and the line of sight is enhanced.

The time prediction unit 14 acquires the display delay r as the time from the start of rendering until the image generated by the rendering is displayed on the display screen.

According to this configuration, variations in rendering time and the like are reflected in the prediction of the line of sight and the line of sight.

The information processing device 10 includes a rendering time measurement unit 17. The rendering time measurement unit 17 measures the rendering time for each frame. The time prediction unit 14 calculates, as the display delay r, a time obtained by adding the buffer time Rb and the response time R_{d}, which are eigenvalues according to the hardware configuration, to the rendering time Rr that varies depending on the complexity of the content to be rendered.

According to this configuration, an appropriate video with less deviation is generated for any content.

The user position prediction unit 13 predicts the viewpoint and the line of sight of the user US at the time when the image of the target frame is predicted to be displayed on the basis of the prediction result of the display delay r, the viewpoint and the line of sight of the user US at the start time of rendering of the target frame, and the moving speed of the viewpoint and the line of sight of the user US at the start time of rendering of the target frame.

According to this configuration, the shift of the video due to the movement of the viewpoint and the line of sight is appropriately suppressed.

The user position prediction unit 13 predicts the viewpoint and the line of sight of the user US on the basis of simple prediction assuming that the moving direction and the moving speed of the viewpoint and the line of sight of the user US are unchanged before and after the rendering start time.

In the simple prediction, the prediction is performed without considering the tendency of the line of sight variation or the like. It is difficult to predict how the viewpoint or the line of sight changes during viewing. By predicting the viewpoint and the line of sight by the simple prediction, simple and highly accurate prediction can be performed.

Note that the effects described in the present specification are merely examples and are not limited, and other effects may be provided.

### Supplementary Note

Note that the present technology can also adopt the following configurations.

(1)

An information processing device comprising:
a rendering unit that generates an image having motion parallax according to a viewpoint and a line of sight of a user;
a time prediction unit that predicts a display delay of an image of a target frame to be rendered on a basis of a display delay measured for a frame before the target frame;
a user position prediction unit that predicts a viewpoint and a line of sight of the user at a time when an image of the target frame is predicted to be displayed on a basis of a prediction result of the display delay; and
a viewpoint/line-of-sight setting unit that sets the predicted viewpoint and line of sight of the user as a viewpoint and line of sight of rendering when an image of the target frame is generated.
   (2)

The information processing device according to (1), wherein
the time prediction unit predicts a display delay of the target frame on a basis of a display delay measured for a frame one frame before the target frame.
   (3)

The information processing device according to (1) or (2), wherein
the time prediction unit acquires the display delay as a time from when rendering is started to when an image generated by the rendering is displayed on a display screen.
   (4)

The information processing device according to (3), comprising:
a rendering time measurement unit that measures a rendering time for each frame, wherein
the time prediction unit calculates, as the display delay, a time obtained by adding a buffer time and a response time, which are eigenvalues according to a hardware configuration, to the rendering time that varies depending on complexity of content to be rendered.
   (5)

The information processing device according to (3) or (4), wherein
the user position prediction unit predicts a viewpoint and a line of sight of the user at a time when an image of the target frame is predicted to be displayed on a basis of a prediction result of the display delay, a viewpoint and a line of sight of the user at a start time of rendering of the target frame, and a moving speed of the viewpoint and the line of sight of the user at the start time of rendering of the target frame.
   (6)

The information processing device according to (5), wherein
the user position prediction unit predicts a viewpoint and a line of sight of the user on a basis of simple prediction assuming that a moving direction and a moving speed of the viewpoint and the line of sight of the user are unchanged before and after a start time of rendering.
   (7)

An information processing method causing a computer to execute:
generating an image having motion parallax according to a viewpoint and a line of sight of a user;
predicting a display delay of an image of a target frame to be rendered on a basis of a display delay measured for a frame before the target frame;
predicting a viewpoint and a line of sight of the user at a time when an image of the target frame is predicted to be displayed on a basis of a prediction result of the display delay; and
setting the predicted viewpoint and line of sight of the user as a viewpoint and line of sight of rendering when an image of the target frame is generated.
   (8)

A computer-readable non-transitory storage medium storing a program for causing a computer to execute:
generating an image having motion parallax according to a viewpoint and a line of sight of a user;
predicting a display delay of an image of a target frame to be rendered on a basis of a display delay measured for a frame before the target frame;
predicting a viewpoint and a line of sight of the user at a time when an image of the target frame is predicted to be displayed on a basis of a prediction result of the display delay; and
setting the predicted viewpoint and line of sight of the user as a viewpoint and line of sight of rendering when an image of the target frame is generated.

### REFERENCE SIGNS LIST

10 INFORMATION PROCESSING DEVICE
13 USER POSITION PREDICTION UNIT
14 TIME PREDICTION UNIT
15 VIEWPOINT/LINE-OF-SIGHT SETTING UNIT
16 RENDERING UNIT
17 RENDERING TIME MEASUREMENT UNIT
r DISPLAY DELAY
R_{b} BUFFER TIME
R_{d} RESPONSE TIME
Rᵣ RENDERING TIME
US USER

1. An information processing device comprising:
a rendering unit that generates an image having motion parallax according to a viewpoint and a line of sight of a user;
a time prediction unit that predicts a display delay of an image of a target frame to be rendered on a basis of a display delay measured for a frame before the target frame;
a user position prediction unit that predicts a viewpoint and a line of sight of the user at a time when an image of the target frame is predicted to be displayed on a basis of a prediction result of the display delay; and
a viewpoint/line-of-sight setting unit that sets the predicted viewpoint and line of sight of the user as a viewpoint and line of sight of rendering when an image of the target frame is generated.

2. The information processing device according to claim 1, wherein
the time prediction unit predicts a display delay of the target frame on a basis of a display delay measured for a frame one frame before the target frame.

3. The information processing device according to claim 1, wherein
the time prediction unit acquires the display delay as a time from when rendering is started to when an image generated by the rendering is displayed on a display screen.

4. The information processing device according to claim 3, comprising:
a rendering time measurement unit that measures a rendering time for each frame, wherein
the time prediction unit calculates, as the display delay, a time obtained by adding a buffer time and a response time, which are eigenvalues according to a hardware configuration, to the rendering time that varies depending on complexity of content to be rendered.

5. The information processing device according to claim 3, wherein
the user position prediction unit predicts a viewpoint and a line of sight of the user at a time when an image of the target frame is predicted to be displayed on a basis of a prediction result of the display delay, a viewpoint and a line of sight of the user at a start time of rendering of the target frame, and a moving speed of the viewpoint and the line of sight of the user at the start time of rendering of the target frame.

6. The information processing device according to claim 5, wherein
the user position prediction unit predicts a viewpoint and a line of sight of the user on a basis of simple prediction assuming that a moving direction and a moving speed of the viewpoint and the line of sight of the user are unchanged before and after a start time of rendering.

7. An information processing method causing a computer to execute:
generating an image having motion parallax according to a viewpoint and a line of sight of a user;
predicting a display delay of an image of a target frame to be rendered on a basis of a display delay measured for a frame before the target frame;
predicting a viewpoint and a line of sight of the user at a time when an image of the target frame is predicted to be displayed on a basis of a prediction result of the display delay; and
setting the predicted viewpoint and line of sight of the user as a viewpoint and line of sight of rendering when an image of the target frame is generated.

8. A computer-readable non-transitory storage medium storing a program for causing a computer to execute:
generating an image having motion parallax according to a viewpoint and a line of sight of a user;
predicting a display delay of an image of a target frame to be rendered on a basis of a display delay measured for a frame before the target frame;
predicting a viewpoint and a line of sight of the user at a time when an image of the target frame is predicted to be displayed on a basis of a prediction result of the display delay; and
setting the predicted viewpoint and line of sight of the user as a viewpoint and line of sight of rendering when an image of the target frame is generated.
